(19) United States
(12) Patent Application Publication
(10) Pub. No.: US 2024/0383445 A1
(43) Pub. Date: Nov. 21, 2024

(54) WIPER DEVICES, VEHICLE-MOUNTED LIDAR, AND VEHICLE

(71) Applicant: AUTOX TECH PTE. LTD.

(72) Inventor: Gaoxiang Tian, Shenzhen (CN)

(73) Assignee: AUTOX TECH PTE. LTD., (omitted)

(21) Appl. No.: 18/668,293

(22) Filed: May 20, 2024

(30) Foreign Application Priority Data
May 19, 2023 (CN) 2023105747195

(51) Int. Cl. B60S 1/24; B60S 1/04

(52) U.S. Cl. CPC B60S 1/24; B60S 1/0491

(57) ABSTRACT

There is provides a wiper device, the wiper device comprises a driving mechanism, a wiper component, and a base. The base defines an opening. the wiper component, is adapted to the opening. The driving mechanism is fixedly connected to the wiper component, and the driving mechanism drives the wiper component to swing; when the wiper component swings, the wiper component gradually opens up a certain angle relative to the base through the opening and extends out of the base, or gradually closes down relative to the base through the opening and hides in the base.

This non-provisional patent application claims priority under 35 U. S. C. § 119 from Chinese Patent Application No. 2023105747195 filed on May 19, 2023, the entire content of which is incorporated herein by reference.

### TECHNICAL FIELD

The disclosure relates to Lidar technology, and more particularly to a wiper device, a vehicle Lidar, and a vehicle.

### BACKGROUND

In existing vehicles, Lidars mounted on the vehicle are often used to collect information and feed back the information to the vehicle's ECU. However, the Lidars on the vehicle are often located outside of the vehicle bodies, and face harsh environments, such as rain, snow, fog, and haze, which can easily lead to dirt on a sensing surface of each Lidar. Furthermore, if the sensing surface is not cleaned for a long time, it can easily make the Lidar be damaged.

### SUMMARY

There are provided a wiper device, a vehicle-mounted Lida using the wiper device, and a vehicle, using the vehicle-mounted, the wiper device can clean the vehicle-mounted Lida, and can be hidden when not working.

In a first aspect, there is provides a wiper device, the wiper device comprises a driving mechanism, a wiper component, and a base. The base defines an opening. the wiper component, is adapted to the opening. The driving mechanism is fixedly connected to the wiper component, and the driving mechanism drives the wiper component to swing; when the wiper component swings, the wiper component gradually opens up a certain angle relative to the base through the opening and extends out of the base, or gradually closes down relative to the base through the opening and hides in the base.

Further, the wiper component comprises a trim cover, a surface shape of the trim cover is adapted to the opening shape; when the wiper component is hidden in the base, the surface of the trim cover is integrated with a surface of the base.

Further, a color and material of the trim cover are consistent with that of the base.

Further, the wiper component further comprises a wiper blade, the wiper blade comprises a supporting portion, a head, and a connecting portion connected between the supporting portion and the head, a certain gap is formed between the supporting portion and the head, and at least one portion of the supporting portion protrudes from one side of the head to form a force bearing part; the head tilts towards the force bearing part under an external force, and is supported by the force bearing part when tilted to an ultimate angle to limit a maximum tilt angle of the head to the ultimate angle.

Further, the head has a cleaning portion and two symmetrically sides adjacent to the cleaning portion, and the cleaning portion is away from the support part; the two sides of the head are concave inward to form an inner concave surface.

Further, the driving mechanism comprises a crank rocker mechanism, a driver, and a worm gear, the crank rocker mechanism comprises a crank, and a rocker rod connected to the crank, the driver comprises a worm shaft adapted to the worm gear, the crank is embedded on the worm gear, the driver drives the worm gear to rotate, the worm shaft drives the worm gear and the crank embedded on the worm gear to move in a circular motion, and the wiper blade swings.

Further, the crank rocker mechanism further comprises a connecting rod, one end of the connecting rod is connected to the rocker rod and the other end is connected to the crank, and the connecting rod is a V-shaped folding rod.

In a second aspect, there is also provided a vehicle-mounted Lidar, the vehicle-mounted Lidar includes above wiper device, and a Lida. Wherein a sensing surface is provided on the side of the Lidar, a bottom surface of the Lidar is fixedly connected to the base, the wiper component is parallel to the sensing surface, and at least one portion of the wiper component is in contact with the sensing surface; the driving mechanism drives the wiper component to perform a swinging motion to clean the sensing surface; or drives the wiper component to be hidden in the base.

Further, the Lidar integrates at least one sensor, which is a visual sensor.

In a third aspect,, there is also provided a vehicle, wherein the vehicle includes a vehicle body and vehicle-mounted Lidar mounted on the vehicle body, and the base is integrally formed with the vehicle body.

As described above, in the wiper device, vehicle-mounted Lidar, and vehicle, the wiper blade is fixed on the rocker rod of the crank rocker mechanism, and the hidden plate is also fixed on the rocker. When cleaning the Lidar, the rocker rod is driven to swing and clean the sensing surface of the Lidar; When not in use, the rocker rod is insert into the base and cover the entire wiper device with a hidden board to achieve a hidden effect. The crank rocker mechanism enables the wiper blade to clean the Lidar; and achieve a hidden effect when not in use. The goal of efficiently utilizing space and maintaining overall aesthetics has been achieved.

### BRIEF DESCRIPTION OF THE DRAWINGS

In order to provide a clearer explanation of the embodiments of the present invention or the technical solutions in the prior art, the following will briefly introduce the accompanying drawings required in the embodiments or descriptions of the prior art. It is obvious that the drawings described below are only some embodiments of the present invention. For those skilled in the art, other drawings can be obtained based on the structures shown in these drawings without creative labor.

FIG. 1 is a schematic diagram of a wiper device in accordance with an embodiment, the wiper device has a wiper blade and a driving mechanism.

FIG. 2 is a schematic diagram of a vehicle-mounted Lidar provided in accordance with an embodiment.

FIG. 3 is enlarged view of a portion of the wiper blade shown in FIG. 1.

FIG. 4 is a schematic diagram of the driving mechanism shown in FIG. 1.

FIG. 5 is a schematic diagram of an internal structure of the vehicle-mounted Lidar in accordance with an embodiment.

FIG. 6 is a top view of a vehicle in accordance with an embodiment.

The implementation, functional characteristics, and advantages of the present invention will be further explained in conjunction with the embodiments, with reference to the accompanying drawings.

### DETAILED DESCRIPTION OF THE EMBODIMENTS

In the description of the present invention, it should be understood that the terms “length”, “width”, “up”, “down”, “front”, “back”, “left”, “right”, “vertical”, “horizontal”, “top”, “bottom”, “inside”, “outside”, etc. indicate that the orientation or position relationship based on the orientation or position relationship shown in the drawings is only for the convenience of describing the present invention and simplifying the description, and does not indicate or imply that the device or element referred to must have a specific orientation, be constructed and operated in a specific orientation. Therefore, it cannot be understood as a limitation of the present invention.

In addition, the terms “first” and “second” are only used to describe the purpose and cannot be understood as indicating or implying relative importance or implying the quantity of technical features indicated. Therefore, the features limited to “first” and “second” can explicitly or implicitly include one or more of these features. In the description of the present invention, “multiple” means two or more, unless otherwise specified.

In the present invention, unless otherwise specified and limited, the terms “installation”, “connection”, “connection”, “fixation” and other terms should be broadly understood, for example, they can be fixed connections, detachable connections, or integrated; It can be a mechanical connection or an electrical connection; It can be directly connected or indirectly connected through an intermediate medium, which can be the internal connection of two components or the interaction relationship between two components. For ordinary technical personnel in this field, the specific meanings of the above terms in the present invention can be understood based on specific circumstances.

To provide a clearer and more accurate understanding of the content of the present invention, detailed explanations will be provided in conjunction with the accompanying drawings. The instruction manual is accompanied by an example of an embodiment of the present invention, where the same reference number represents the same component. It can be understood that the proportions shown in the accompanying drawings of the specification are not the actual proportions implemented in the present invention, and are only for illustrative purposes and not drawn according to the original dimensions.

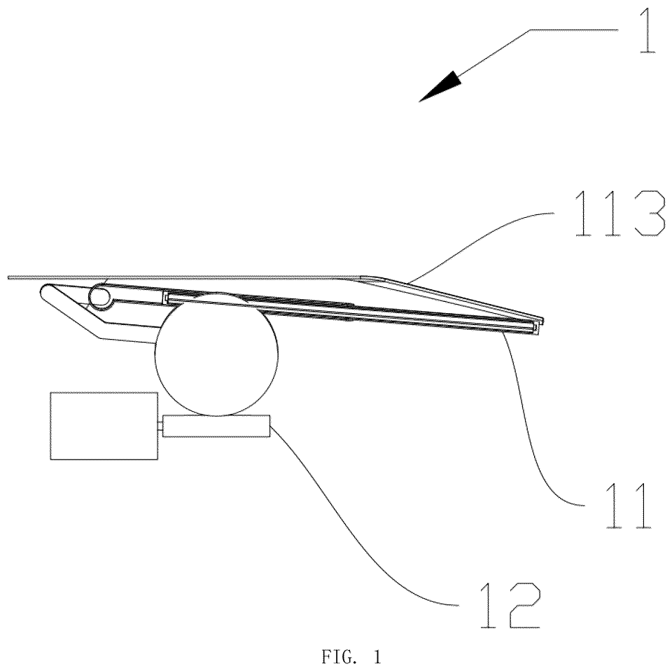

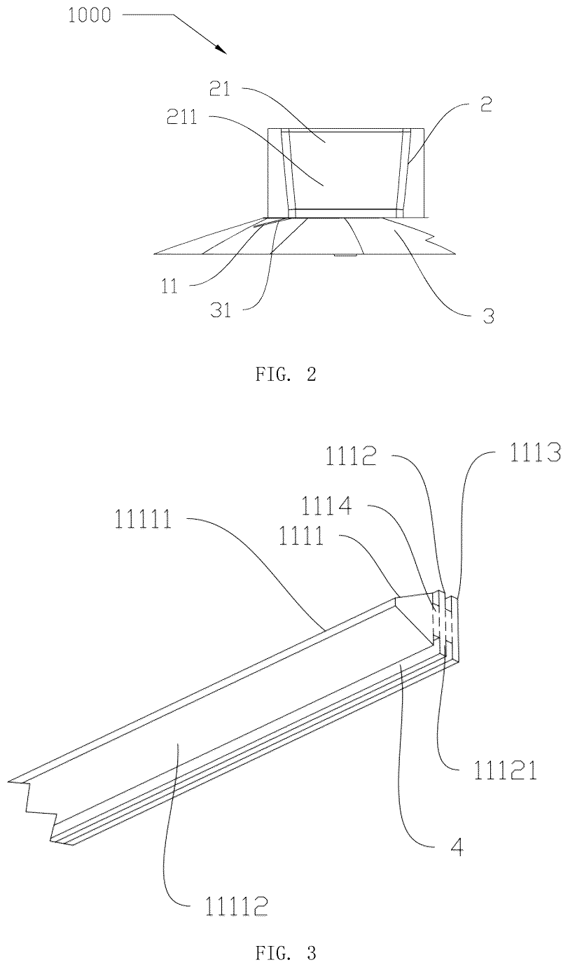

Referring to FIGS. 1-2. FIG, 1 is a schematic diagram of a wiper device in accordance with an embodiment, and FIG. 2 is a front view of the vehicle mounted Lidar in accordance with an embodiment.

The wiper device 1 includes a driving mechanism 12, a wiper component 11, and a base 3. The base 3 defines an opening 31, and the wiper component 11 fits into the opening 31. The wiper component 11 is hidden in the base 3, and the driving mechanism 12 is fixedly connected to the wiper component 11. The driving mechanism 12 drives the wiper component 11 to swing. When the wiper component 11 swings, the wiper component 11 gradually opens up a certain angle with respective to the base 3 through opening 31 and extends out of base 3, or gradually closes down with respective to the base 3 through opening 31 and hides in base 3.

In detail, the wiper device 1 is configured to clean a vehicle-mounted Lidar and is also suitable for cleaning emitted surfaces and illuminated surfaces of any other Lidar.

Referring to FIG. 3, FIG. 3 illustrates an enlarged view of a portion of the wiper blade in accordance with an embodiment.

The wiper component 11 includes a wiper blade 111, a mounting element 112, and a trim cover 113. The wiper blade 111 is installed on the mounting part 112, and the mounting part 112 and the trim cover 113 are disposed on the two adjacent sides of a rocker rod 1211 of the driving mechanism. Further, the wiper component 11 is disposed on a side parallel to a cleaning object, and the trim cover 113 is disposed on the side perpendicular to wiper component 11. When the wiper device 1 swings, the rocker rod 1211 takes the wiper blade 111 to gradually open up a certain angle relative to the base 3 and extend out of the base 3, that wiper component 11 can be capable of reciprocating motion to clean objects; the rocker rod 1211 drives the wiper component 11 and the trim cover 113 to move inward from the opening 31 towards the base 3, so that rocker rod 1211 and the wiper component 11 gradually close downwards relative to the base 3 through the opening 31 and hide in the base 3.

The installation part 112 defines an installation groove 1121 for installing the wiper blade 111. A rear side of the wiper blade 111 installed by the installation part 112 is fixedly connected to the rocker rod 1211. The wiper blade 111 is used for cleaning in contact with objects. The installation part 112 is roughly rectangular in shape and has an installation groove 1121.

The wiper blade 111 includes a supporting portion 1112, a head 1111, a connecting portion 1114 connected between the supporting portion 1112 and the head 1111, and a fixing portion 1113. The fixing part 1113 is embedded in the installation groove 1121 to fix the installation part 112 with the wiper blade 111. The head 1111, the connecting portion 1114, the supporting portion 1112, and the fixing portion 1113 are sequentially connected, and a certain gap 4 is formed between the head 1111 and the supporting portion 1112 due to the connecting portion 1114. In detail, the fixing part 1113 is a rectangle adapted to the installation groove 1121, configured to clip the wiper blade 111 in the installation groove 1121.

In this embodiment, the wiper blade 111 is substantially in a long strip shape, and the wiper blade 111 is made of rubber material. In detail, the head 1111 is substantially a trapezoidal body with a narrow top and a wide bottom, and the wide bottom of the trapezoidal body is connected to the support part 1112. The head 1111 has a cleaning portion 11111, which is located on both sides of the head 1111 away from the support part 1112. The head 1111 also includes two sides 11112 adjacent to the cleaning portion 11111, both of which are inclined outward relative to the head 1111.

In this embodiment, the two sides of the head 1111 are concave curves, which can prevent the head 1111 and the sensing surface 21 from changing from line contact to surface contact when a excessive pressure applied to the head 1111. The short bottom edge of the head 1111 is the cleaning portion 11111, configured to clean the sensing surface 21 when contacting with the sensing surface 21.

The supporting portion 1112 is substantially a plate, and at least a part of the supporting portion 1112 protrudes to one side of the head 1111 to form a force bearing part 11121. The head 1111 tilts towards the force bearing part 11121 under an external force, and is supported by the force bearing part 11121 when tilted to an ultimate angle, to limit the maximum tilt angle of the head 1111 as the ultimate angle. In this embodiment, the support portion 1112 includes two force bearing portions 11121 symmetrically protruding on both sides of the head 1111. The force bearing part 11121 is a flat plate wing, and the gap 4 is located between the force bearing part 11121 and the head 1111. The force bearing part 11121 protrudes on both sides away from the wiper blade 111. From a cross-section of wiper blade 111, a cross-section of supporting portion 1112 is a cross shape, with two symmetrical ends of the cross shape being the force bearing part 11121. The fixing part 1113 and the head 1111 are respectively connected to the other two ends of the cross shape. The force bearing part 11121 allows the head 1111 of the wiper blade to support the head 1111 when the head 1111 is tilted to left or right under a force, increasing a certain pressure and improving the cleaning effect between the head 1111 and the sensing surface 21.

A shape of the surface of trim cover 113 matches a shape of a surface surrounding the opening 31. After cleaning, when the wiper component 11 is hidden in base 3, the trim cover 113 covers the opening 31, and the surface of the trim cover 113 is integrated with the surface of base 3. In detail, the color and material of trim cover 113 are consistent with base 3. When the trim cover 113 is integrated with base 3, that can enhance the overall aesthetic of the design.

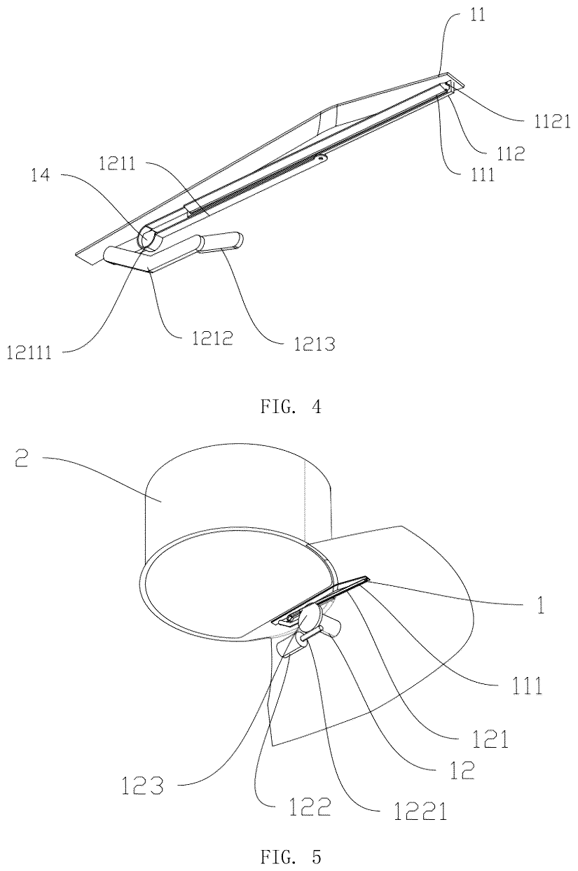

Referring to FIG. 4, FIG. 4 shows a schematic diagram of the driving mechanism in accordance with an embodiment.

The driving mechanism 12 includes a crank rocker mechanism 121, a driver 122, and a worm gear 123. The driver 122 drives the worm gear 123 to swing the crank rocker mechanism 121.

The rocker rod 1211 contained in the crank rocker mechanism 121, and the crank rocker mechanism 121 further includes a crank 1213, and a connecting rod 1212. One end of the connecting rod 1212 is connected to the rocker rod 1211, and the other end is connected to the crank 1213. The driver 122 includes a worm shaft 1221 adapted to the worm gear 123. The crank 1213 is embedded on the worm gear 123. When the wiper device 1 is activated, the driver 122 drives the worm shaft 1221 to rotate. The worm shaft 1221 drives the worm gear 123 and the crank 1213 embedded on the worm gear 123 to move in a circular motion. The wiper blade 111 swings on the sensing surface 21.

In detail, the connecting rod 1212 is a V-shaped folding rod. The connecting rod 1212 is to avoid other components. If it is a linear connecting rod, there may be collisions between the connecting rods during rotation.

In this embodiment, the driver 122 is a motor, which is adapted to the worm shaft 1221 and is configured to drive the worm shaft 1221 to rotate. That is, the worm shaft 1221 is connected on the output shaft of the motor, or a thread engraved on the output shaft of the motor compatible with the worm gear 123. The motor is powered on, the output shaft drives the worm gear 123 to rotate, and finally drives the wiper blade 111 on the rocker rod 1211 to move back and forth on the cleaning object, therefore, the sensing surface 21 is cleaned because that the cleaning portion 11111 and the cleaning object rubs against each other.

The driving mechanism 12 also includes a rotating shaft 14, and the rocker rod 1211 includes a fixing hole 12111. The fixing hole 12111 is set at one end of the rocker rod 1211 near the connecting rod 1212, and the rotating shaft 14 passes through the fixing hole 12111. When crank 1213 performs circular motion, it drives rocker rod 1211 to rotate around the rotation axis 14.

In detail, the rotation axis 14 is connected to the base 3 or any fixed point, and the rotation axis 14 is the polished rod axis.

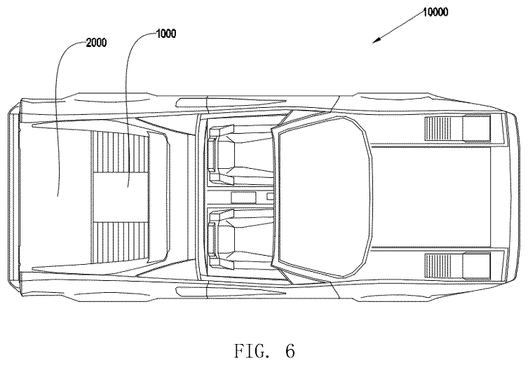

Referring to FIG. 5, FIG. 5 illustrates a schematic diagram of an internal structure of the vehicle mounted Lidar in accordance with an embodiment.

The vehicle-mounted Lidar 1000 includes a wiper device 1 and Lidar 2. One side of Lidar 2 is provided with a sensing surface 21, and the bottom surface of the Lidar 2 is fixedly connected to the base 3. The wiper component 11 is parallel to the sensing surface 21, and at least a part of the wiper component 11 is in contact with the sensing surface 21. The driving mechanism 12 drives the wiper component 11 to swing and clean the sensing surface 21, Or drive the wiper component 11 to be hidden in the base 3.

In detail, Lidar can be but not limited to be vehicle-mounted millimeter wave Lidars, vehicle-mounted ultrasonic Lidars, etc. In this embodiment, the Lidar integrates at least one sensor, and the sensor in this embodiment is a visual sensor. The visual sensor is electrically connected to the driving computer to assist in intelligent driving of the vehicle.

In detail, in this embodiment, a shape of the base 3 is similar to a curved shape of a corner of the vehicle roof. In other embodiments, shape of the base 3 is to accommodate the wiper device 1, which can be a closed base or a partial component embedded in the vehicle body 2000. That is, in this embodiment, the corresponding shape may be accommodate or support the wiper device 1, without specific limitations.

Referring to FIG. 6, FIG. 6 illustrates a top view of the vehicle.

The vehicle 10000 includes the vehicle body 2000 and the vehicle-mounted Lidar 1000, which are disposed on the vehicle body 2000. The specific structure of the vehicle mounted Lidar 1000 refers to the above embodiment. The vehicle-mounted Lidar 1000 is electrically connected to the vehicle's ECU, and Lidar 2 transmits signals to the vehicle's ECU, which controls the vehicle's autonomous driving. The vehicle ECU controls the wiper device 1 to clean the Lidar 2 and maintain the accuracy of the signal. It can be understood that in some embodiments, the onboard Lidar 1000 is designed as a whole for the vehicle itself, so the base 3 of the onboard Lidar 1000 is integrated with the vehicle body 2000.

In the above embodiment, by fixing the wiper blade to the rocker rod of the crank rocker mechanism and also fixing the hidden plate to the rocker, when cleaning the Lidar, the rocker rod is driven to move back and forth to clean the sensing surface of the Lidar; when not in use, the rocker rod is inserted into the base and cover the entire wiper device with a hidden board to achieve a hidden effect. The crank rocker mechanism enables cleaning of the Lidar and achieves a hidden effect when not in use.

Obviously, technicians in this field can make various modifications and variations to the present invention without departing from the spirit and scope of the present invention. In this way, if these modifications and variations of the present invention fall within the scope of the claims and their equivalent technologies, the present invention is also intended to include these modifications and variations.

The above listed examples are only the preferred embodiments of the present invention, and of course, they cannot be used to limit the scope of the present invention. Therefore, the equivalent changes made according to the claims of the present invention still fall within the scope of the present invention.

1. A wiper device, comprises
a base, defined an opening;
a wiper component, adapted to the opening; and
a driving mechanism, fixedly connected to the wiper component, and the driving mechanism driving the wiper component to swing; wherein when the wiper component swings, the wiper component gradually opens up a certain angle relative to the base through the opening and extends out of the base, or gradually closes down relative to the base through the opening and hides in the base.

2. The wiper device of claim 1, wherein the wiper component comprises a trim cover, a surface shape of the trim cover is adapted to the opening shape; when the wiper component is hidden in the base, the surface of the trim cover is integrated with a surface of the base.

3. The wiper device of claim 2, wherein a color and material of the trim cover are consistent with that of the base.

4. The wiper device of claim 1, wherein the wiper component further comprises a wiper blade, the wiper blade comprises a supporting portion, a head, and a connecting portion connected between the supporting portion and the head, a certain gap is formed between the supporting portion and the head, and at least one portion of the supporting portion protrudes from one side of the head to form a force bearing part; the head tilts towards the force bearing part under an external force, and is supported by the force bearing part when tilted to an ultimate angle to limit a maximum tilt angle of the head to the ultimate angle.

5. The wiper device of claim 4, wherein the head has a cleaning portion and two symmetrically sides adjacent to the cleaning portion, and the cleaning portion is away from the support part; the two sides of the head are concave inward to form an inner concave surface.

6. The wiper device of claim 1, wherein the driving mechanism comprises a crank rocker mechanism, a driver, and a worm gear, the crank rocker mechanism comprises a crank, and a rocker rod connected to the crank, the driver comprises a worm shaft adapted to the worm gear, the crank is embedded on the worm gear, the driver drives the worm gear to rotate, the worm shaft drives the worm gear and the crank embedded on the worm gear to move in a circular motion, and the wiper blade swings.

7. The wiper device of claim 6, wherein the crank rocker mechanism further comprises a connecting rod, one end of the connecting rod is connected to the rocker rod and the other end is connected to the crank, and the connecting rod is a V-shaped folding rod.

8. A vehicle-mounted Lidar, comprising:
a wiper device, comprising:
a base, defined an opening;
a wiper component, adapted to the opening; and
a driving mechanism, fixedly connected to the wiper component, and the driving mechanism driving the wiper component to swing; wherein when the wiper component swings, the wiper component gradually opens up a certain angle relative to the base through the opening and extends out of the base, or gradually closes down relative to the base through the opening and hides in the base;
a Lidar, having a sensing surface, wherein a sensing surface is provided on the side of the Lidar, a bottom surface of the Lidar is fixedly connected to the base, the wiper component is parallel to the sensing surface, and at least one portion of the wiper component is in contact with the sensing surface; the driving mechanism drives the wiper component to perform a swinging motion to clean the sensing surface; or drives the wiper component to be hidden in the base.

9. The vehicle-mounted Lidar of claim 8, wherein the wiper component comprises a trim cover, a surface shape of the trim cover is adapted to the opening shape; when the wiper component is hidden in the base, the surface of the trim cover is integrated with a surface of the base.

10. The vehicle-mounted Lidar of claim 9, wherein a color and material of the trim cover are consistent with that of the base.

11. The vehicle-mounted Lidar of claim 10, wherein the wiper component further comprises a wiper blade, the wiper blade comprises a supporting portion, a head, and a connecting portion connected between the supporting portion and the head, a certain gap is formed between the supporting portion and the head, and at least one portion of the supporting portion protrudes from one side of the head to form a force bearing part; the head tilts towards the force bearing part under an external force, and is supported by the force bearing part when tilted to an ultimate angle to limit a maximum tilt angle of the head to the ultimate angle.

12. The vehicle-mounted Lidar of claim 11, wherein the head has a cleaning portion and two symmetrically sides adjacent to the cleaning portion, and the cleaning portion is away from the support part; the two sides of the head are concave inward to form an inner concave surface.

13. The vehicle-mounted Lidar of claim 8, wherein the driving mechanism comprises a crank rocker mechanism, a driver, and a worm gear, the crank rocker mechanism comprises a crank, and a rocker rod connected to the crank, the driver comprises a worm shaft adapted to the worm gear, the crank is embedded on the worm gear, the driver drives the worm gear to rotate, the worm shaft drives the worm gear and the crank embedded on the worm gear to move in a circular motion, and the wiper blade swings.

14. The vehicle-mounted Lidar of claim 13, wherein the crank rocker mechanism further comprises a connecting rod, one end of the connecting rod is connected to the rocker rod and the other end is connected to the crank, and the connecting rod is a V-shaped folding rod.

15. The vehicle mounted Lidar of claim 8, wherein the Lidar integrates at least one sensor.

16. The vehicle mounted Lidar of claim 15, wherein the at least one sensor is a visual sensor.

17. The vehicle mounted Lidar of claim 8, wherein the Lidar is a vehicle-mounted millimeter wave Lidar, or a vehicle-mounted ultrasonic Lidars.

18. A vehicle, comprises
a body; and
a vehicle-mounted Lidar; the vehicle-mounted Lidar comprising:
a wiper device, comprising:
a base, defined an opening;
a wiper component, adapted to the opening; and
a driving mechanism, fixedly connected to the wiper component, and the driving mechanism driving the wiper component to swing; wherein when the wiper component swings, the wiper component gradually opens up a certain angle relative to the base through the opening and extends out of the base, or gradually closes down relative to the base through the opening and hides in the base;
a Lidar, having a sensing surface, wherein a sensing surface is provided on the side of the Lidar, a bottom surface of the Lidar is fixedly connected to the base, the wiper component is parallel to the sensing surface, and at least one portion of the wiper component is in contact with the sensing surface; the driving mechanism drives the wiper component to perform a swinging motion to clean the sensing surface; or drives the wiper component to be hidden in the base.

19. The vehicle of claim 18, wherein the wiper component comprises a trim cover, a surface shape of the trim cover is adapted to the opening shape; when the wiper component is hidden in the base, the surface of the trim cover is integrated with a surface of the base.

20. The vehicle of claim 18, wherein the wiper component further comprises a wiper blade, the wiper blade comprises a supporting portion, a head, and a connecting portion connected between the supporting portion and the head, a certain gap is formed between the supporting portion and the head, and at least one portion of the supporting portion protrudes from one side of the head to form a force bearing part; the head tilts towards the force bearing part under an external force, and is supported by the force bearing part when tilted to an ultimate angle to limit a maximum tilt angle of the head to the ultimate angle.
